(19) United States
(12) Patent Application Publication
(10) Pub. No.: US 2026/0058120 A1
(43) Pub. Date: Feb. 26, 2026

(54) MANUFACTURING APPARATUS FOR ELECTRODE SHEET AND MANUFACTURING METHOD FOR ELECTRODE SHEET

(71) Applicant: TOYOTA JIDOSHA KABUSHIKI KAISHA, Toyota-shi (JP)

(72) Inventors: Yosuke SHIMURA, Nagakute-shi (JP); Kengo HAGA, Nagoya-shi (JP); Tomofumi HIRUKAWA, Miyoshi-shi (JP); Hiroshi KAWASAKI, Toyota-shi (JP)

(73) Assignee: TOYOTA JIDOSHA KABUSHIKI KAISHA, Toyota-shi (JP)

(21) Appl. No.: 19/187,070

(22) Filed: Apr. 23, 2025

(30) Foreign Application Priority Data
Aug. 23, 2024 (JP) 2024-143389

(51) Int. Cl. H01M 4/04

(52) U.S. Cl. CPC H01M 4/0471; H01M 4/0404

(57) ABSTRACT

A manufacturing apparatus of an electrode sheet includes a transport device configured to transport a coated sheet in a state where a first surface of the coated sheet on a coated part side of a coated sheet having a coated part to which an electrode material is applied on a first surface of a current collector sheet is supported on a second surface of the coated sheet opposite to the first surface, and a laser irradiation device configured to dry the coated part by irradiating the coated sheet transported by the transport device with a laser L, in which the laser irradiation device is disposed on a second surface side of the coated sheet transported by the transport device and includes a laser head configured to irradiate the laser L toward the second surface of the coated sheet.

### CROSS-REFERENCE TO RELATED APPLICATION

This application claims priority to Japanese Patent Application No. 2024-143389 filed on August 23, 2024. The disclosure of the above-identified application, including the specification, drawings, and claims, is incorporated by reference herein in its entirety.

### BACKGROUND

### 1. Technical Field

The present disclosure relates to a manufacturing apparatus for an electrode sheet and a manufacturing method for an electrode sheet.

### 2. Description of Related Art

As a technology related to a manufacturing method for an electrode sheet used for manufacturing a battery such as a lithium ion secondary battery, a method of forming a coated part by coating a current collector sheet with an electrode material and drying the coated part to obtain an electrode layer is known. As a technology for drying the coated part, a technology for irradiating the coated part with a laser has been proposed.

For example, Japanese Unexamined Patent Application Publication No. 2023-169591 (JP 2023-169591 A) discloses an electrode body manufacturing apparatus including a transport unit, a laser irradiation unit, and a vapor recovery unit. The transport unit transports an electrode body coated with at least one electrode material. The laser irradiation unit dries the electrode material by irradiating the electrode material with a laser when the electrode material is transported to at least one first position in a transport direction of the transport unit. The vapor recovery unit is provided at least one second position adjacent to the first position in the transport direction, and recovers the vapor generated due to the irradiation of the electrode material with the laser.

In the technology described in JP 2023-169591 A, the laser is irradiated from a laser irradiation device (laser irradiation unit) toward one surface of a coated sheet (electrode body) while the coated sheet is transported. The coated sheet is transported in a state where a surface on the opposite side of the coated sheet from a coated part (electrode material) side surface is supported.

### SUMMARY

By the way, in a case of manufacturing a large-area electrode sheet, a focal distance of a laser needs to be secured in order to secure a laser irradiation area. In this case, the laser irradiation device is provided at a position away from the coated sheet. However, as the position of the laser irradiation device is separated from the coated sheet, the electrode body manufacturing apparatus is increased in size. Therefore, in the technology described in JP 2023-169591 A, there is a problem that, as the electrode body manufacturing apparatus is increased in size, the cost, such as the amount of equipment investment or the running cost, may increase.

The present disclosure has been made to solve such problems, and an object of the present disclosure is to provide a manufacturing apparatus for an electrode sheet and a manufacturing method for an electrode sheet capable of suppressing an increase in cost due to an increase in size of the manufacturing apparatus by achieving downsizing of the manufacturing apparatus.

A manufacturing apparatus for an electrode sheet according to an aspect includes: a transport device configured to transport a coated sheet including a coated part in a state where a second surface on an opposite side of the coated sheet from a first surface of the coated sheet on a coated part side is supported, the coated part being coated with an electrode material on a first surface of a current collector sheet; and a laser irradiation device configured to dry the coated part by irradiating the coated sheet transported by the transport device with a laser, in which the laser irradiation device includes a laser head disposed on a second surface side of the coated sheet transported by the transport device, the laser head being configured to irradiate the coated sheet with the laser in a direction toward the second surface of the coated sheet.

A manufacturing method for an electrode sheet according to an aspect includes: transporting a coated sheet including a coated part in a state where a second surface on an opposite side of the coated sheet from a first surface of the coated sheet on a coated part side is supported, the coated part being coated with an electrode material on a first surface of a current collector sheet; and drying the coated part by irradiating the coated sheet transported with a laser from a laser irradiation device, in which the laser irradiation device is disposed on a second surface side of the coated sheet transported and irradiates the coated sheet with the laser in a direction toward the second surface of the coated sheet.

According to the present disclosure, it is possible to provide a manufacturing apparatus for an electrode sheet and a manufacturing method for an electrode sheet capable of suppressing an increase in cost due to an increase in size of the manufacturing apparatus by achieving downsizing of the manufacturing apparatus.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a first diagram showing a configuration of an electrode sheet manufacturing apparatus according to Embodiment 1;

FIG. 2 is a second diagram showing a configuration of an electrode sheet manufacturing apparatus according to Embodiment 1;

FIG. 3 is a flowchart showing a manufacturing method for an electrode sheet according to Embodiment 1;

FIG. 4 is a cross-sectional view showing an electrode sheet;

FIG. 5 is a diagram showing a configuration of a manufacturing apparatus for an electrode sheet according to a comparative example; and

FIG. 6 is a graph showing a change with time of the surface temperature of the coated part during drying.

### DETAILED DESCRIPTION OF EMBODIMENTS

### Embodiment 1

Hereinafter, embodiments of the present disclosure will be described with reference to the drawings. Note that the present disclosure is not limited to the following embodiments. Further, in order to clarify the explanation, the following description and drawings are appropriately simplified.

### Manufacturing Apparatus for Electrode Sheet

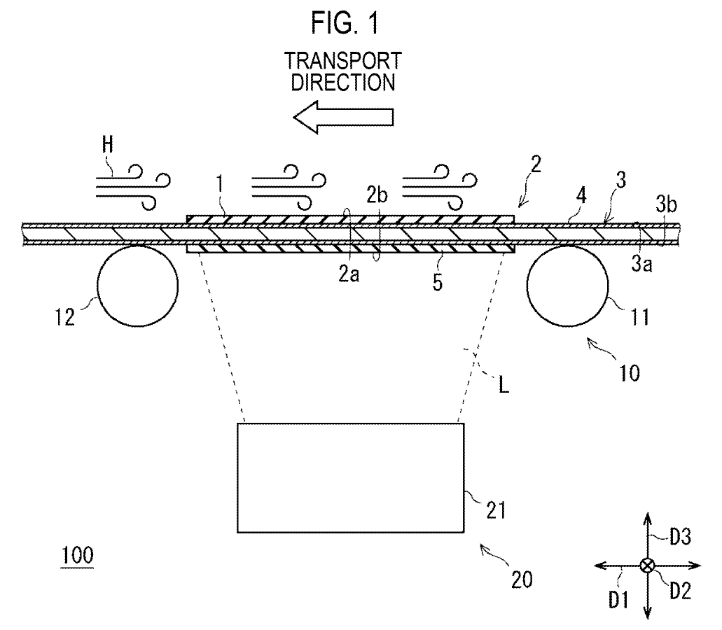

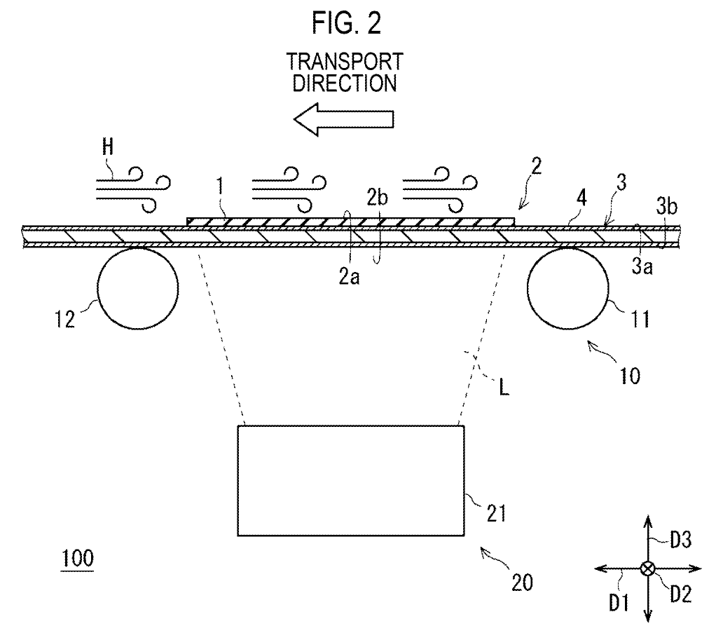

FIG. 1 is a first diagram showing a configuration of an electrode sheet manufacturing apparatus according to Embodiment 1. FIG. 2 is a second diagram showing a configuration of an electrode sheet manufacturing apparatus according to Embodiment 1. A manufacturing apparatus 100 that is a manufacturing apparatus for an electrode sheet according to the first embodiment is a device that manufactures an electrode sheet.

As shown in FIGS. 1 and 2, the manufacturing apparatus 100 includes a transport device 10 that transports a coated sheet 2 having a coated part 1 in which an electrode material is coated, and a laser irradiation device 20 that dries the coated part 1 by irradiating the coated sheet 2 with a laser L. The manufacturing apparatus 100 may have a coating machine in addition to the transport device 10 and the laser irradiation device 20.

Here, for example, in a case of manufacturing a large-area electrode sheet, the laser irradiation device 20 is disposed at a position away from the coated sheet 2 in order to secure the focal distance of the laser L to increase the irradiation area of the laser L. However, as the position of the laser irradiation device 20 is separated from the coated sheet 2, the device is increased in size. In a case where the device is increased in size, there is a problem that a cost, such as an equipment investment amount or a running cost, is likely to increase.

Therefore, the transport device 10 transports the coated sheet 2 in a state where the second surface 2b of the coated sheet 2 is supported by the transport device 10 in a direction opposite to the first surface 2a of the coated sheet 2 on the coated part 1 side of the coated sheet 2 having the coated part 1 to which the electrode material is applied, on the first surface 3a of the current collector sheet 3. The laser irradiation device 20 dries the coated part 1 by irradiating the coated sheet 2 transported by the transport device 10 with the laser L. The laser irradiation device 20 is disposed on the second surface 2b side of the coated sheet 2 transported by the transport device 10, and has a laser head 21 that irradiates the laser L toward the second surface 2b of the coated sheet 2.

With the manufacturing apparatus 100 configured as described above, it is possible to suppress an increase in cost due to enlargement of the device by realizing the reduction in size of the device.

### Coated Sheet

First, a detailed configuration of the coated sheet 2 will be described. The current collector sheet 3 has a longitudinal direction in a first direction D1. The current collector sheet 3 has a first surface 3a and a second surface 3b, which is a back surface of the first surface 3a, in the thickness direction. The current collector sheet 3 is preferably used as a power collector, such as a negative electrode power collector, a positive electrode power collector, or a bipolar power collector.

As the current collector sheet 3, for example, a metal foil such as aluminum, copper, nickel, stainless steel, or an alloy thereof is used. The current collector sheet 3 may be a foil in which a plurality of metal foils is integrated.

The current collector sheet 3 may have at least a carbon coating layer 4 containing a carbon material on the second surface 3b. The carbon coating layer 4 may be provided on not only the second surface 3b of the current collector sheet 3 but also the first surface 3a, as shown in FIGS. 1 and 2. The carbon coating layer 4 may be provided solely on the second surface 3b of the current collector sheet 3. In addition, the carbon coating layer 4 may be provided on the outer surface including the first surface 3a and the second surface 3b of the current collector sheet 3. Examples of the carbon material included in the carbon coating layer 4 include carbon black, graphite, carbon nanotubes, graphene, and vapor phase method carbon fibers.

The current collector sheet 3 may have a coating layer other than the carbon coating layer 4 on at least a part of the outer surface. The coating layer has a function of reducing resistance.

The thickness of the current collector sheet 3 is, for example, 0.1 μm or more, and may be 1 μm or more. On the other hand, the thickness of the current collector sheet 3 is, for example, 1 mm or less, and may be 100 μm or less.

The electrode material may be a negative electrode material. The negative electrode material is a material of the negative electrode active material layer. The negative electrode material contains, for example, a negative electrode active material, a conductive material, a binder, a thickener, and a solvent. The electrode material may be a positive electrode material. The positive electrode material is a material of the positive electrode active material layer. The positive electrode material contains, for example, a positive electrode active material, a conductive material, a binder, a thickener, and a solvent. The materials are not particularly limited, and known materials are used.

As shown in FIG. 1, the coated sheet 2 may have the electrode layer 5 on the second surface 3b opposite to the first surface 3a of the current collector sheet 3. From the viewpoint of efficiently drying the coated part 1, the coated sheet 2 preferably has at least one of the carbon coating layer 4 and the electrode layer 5. The electrode layer 5 may be a negative electrode active material layer or may be a positive electrode active material layer. The negative electrode active material layer contains a negative electrode active material. The negative electrode active material is not particularly limited, and examples of the negative electrode active material include carbon materials, such as artificial graphite, natural graphite, hard graphitized carbon, easy graphitized carbon, and carbon nanotubes. The negative electrode active material layer may contain a conductive material, a binder, a thickener, or the like in addition to the negative electrode active material. The positive electrode active material layer contains a positive electrode active material. The positive electrode active material is not particularly limited, and examples of the positive electrode active material include lithium transition metal oxide, lithium manganese phosphate, and lithium iron phosphate. The positive electrode active material layer may contain a conductive material, a binder, a thickener, or the like in addition to the positive electrode active material.

The coated sheet 2 may have a plurality of coated parts 1 arranged along a predetermined direction on the first surface 3a of the current collector sheet 3. The coated sheet 2 may have an uncoated part in which the electrode material is not coated. For example, the coated part 1 is disposed at a central portion of the current collector sheet 3 in the short hand direction, and the uncoated portion is disposed at both end portions of the current collector sheet 3 in the short hand direction with the coated part 1 interposed therebetween. In a case where the electrode material is intermittently coated, the coated sheet 2 may have an intermittent portion in which the electrode material is not coated.

The coated sheet 2 has a black portion on the second surface 3b of the current collector sheet 3 opposite to the first surface 3a, and the black portion is preferably formed at a position where at least a part of the black portion overlaps the coated part 1 when viewed from the thickness direction of the coated sheet 2. The black portion includes, for example, a black material such as a carbon material and has a black color. The black portion efficiently absorbs the irradiated laser L. Therefore, by irradiating the coated part 1 with the laser L toward the second surface 2b of the coated sheet 2 having the black portion, the coated part 1 can be dried more efficiently.

It is preferable that the black portion is at least one of the carbon coating layer 4 and the electrode layer 5. As a result, there is no need to perform processing for improving the efficiency of drying by laser irradiation on the coated sheet 2, and thus it is possible to suppress an increase in cost for such processing.

The coated sheet 2 can be manufactured, for example, by transporting the current collector sheet 3 in the first direction D1 by the transport device 10, and coating the first surface 3a of the current collector sheet 3 with the electrode material by the coater to form the coated part 1. A coating machine that coats the electrode material on the first surface 3a of the current collector sheet 3 to form the coated part 1 is disposed on an upstream side in the transport direction with respect to the laser irradiation device 20. In this case, the electrode material may be continuously coated or intermittently coated.

### Transport Device

Next, a detailed configuration of the transport device 10 will be described. The transport device 10 transports the coated sheet 2 in a first direction D1. The transport device 10 transports the coated sheet 2 at a predetermined transport speed, for example.

The transport device 10 has transport rollers 11, 12. The transport rollers 11, 12 are disposed to be spaced apart from each other along the first direction D1. The transport roller 11 is disposed on an upstream side in the transport direction indicated by a white arrow in FIG. 1 with respect to the transport roller 12. The transport roller 12 is disposed downstream of the transport roller 11 in the transport direction.

The transport rollers 11, 12 are each cylindrical. The transport rollers 11, 12 rotate around rotation shafts extending in a second direction D2 orthogonal to the first direction D1. The transport rollers 11, 12 are rotationally driven by a drive source, such as a motor. Such a transport device 10 transports the coated sheet 2 by rotating the transport rollers 11, 12 by a drive source.

The transport rollers 11, 12 are disposed on the second surface 2b side of the coated sheet 2 and are support members that support the second surface 2b of the coated sheet 2. The transport device 10 transports the coated sheet 2 in a state of supporting the second surface 2b of the coated sheet 2 with the transport rollers 11, 12.

### Laser Irradiation Device

Next, a detailed configuration of the laser irradiation device 20 will be described. The laser irradiation device 20 is disposed between the transport rollers 11, 12. The laser irradiation device 20 may have a laser oscillator in addition to the laser head 21. The laser head 21 is provided with an optical lens having a predetermined curvature. The laser head 21 oscillates the laser L, for example, from a laser oscillator, and irradiates the coated sheet 2 with the laser L through an optical lens.

An irradiation direction of the laser L shown in FIGS. 1 and 2 is a direction from a second side (lower side) of a third direction D3 orthogonal to a first direction D1 and a second direction D2 to a first side (upper side). Therefore, the laser irradiation device 20 irradiates the coated sheet 2 with the laser from the laser head 21, the coated sheet 2 passing above the laser head 21. The laser irradiation device 20 dries the liquid coated part 1 with the heat of the laser L. The coated part 1 can be dried by the laser irradiation device 20, and thus the electrode sheet can be obtained.

From the viewpoint of shortening the time needed for the coated part 1 to dry while suppressing the deterioration in quality of the electrode sheet, the energy density of the laser L is, for example, 0.1 W/cm² or more and 4.0 W/cm² or less. When the energy density of the laser L is less than 0.1 W/cm², the time needed for the drying of the coated part 1 may be increased. When the energy density of the laser L exceeds 4.0 W/cm², the coated sheet 2 may be overheated, which may cause a decrease in quality.

The wavelength of the laser L is, for example, a wavelength in a near-infrared region to an infrared region. The wavelength of the laser L is preferably a wavelength in a near-infrared region. The laser L having a wavelength in the near-infrared region is easily absorbed by the black portion, and thus the coated part 1 can be more efficiently dried.

The kind of the laser L is preferably a laser having a wavelength in the above-described range. Such a laser L includes, for example, a semiconductor laser, a fiber laser, a solid-state laser, and a carbon dioxide laser. From the viewpoint of efficiently drying the coated part 1, it is preferable that the laser L includes a semiconductor laser. The laser L including the semiconductor laser is suitable for manufacturing an electrode sheet having a large area since an irradiation area of about A4 size can be obtained.

The laser irradiation device 20 may have a plurality of laser heads 21. In this case, the laser heads 21 are preferably disposed to be spaced apart from each other along the first direction D1 on the second surface 2b side of the coated sheet 2 to be transported.

### Hot Air Dryer

The manufacturing apparatus 100 may have a hot air drying machine in addition to the transport device 10 and the laser irradiation device 20. The hot air dryer is disposed on an upstream side or a downstream side in the transport direction with respect to the laser irradiation device 20. In a case where the manufacturing apparatus 100 has the coating device, the hot air drying machine is disposed on a downstream side in the transport direction than the coating device. The hot air dryer supplies the coated part 1 of the coated sheet 2 transported by the transport device 10 with the hot air H. As a result, the coated part 1 can be dried more efficiently.

The temperature of the hot air H is, for example, 50°C or higher and 200°C or lower from the viewpoint of shortening the time needed for the drying of the coated part 1 while suppressing the deterioration of the quality of the electrode sheet. When the temperature of the hot air H is lower than 50°C, the time needed for the drying of the coated part 1 may be increased. When the temperature of the hot air H exceeds 200°C, the coated sheet 2 may be overheated, which may cause a decrease in quality.

The wind speed of the hot air H is, for example, 1 m/s or higher and 15 m/s or lower from the viewpoint of shortening the time needed for the drying of the coated part 1 while suppressing the deterioration of the quality of the electrode sheet. When the wind speed of the hot air H is less than 1 m/s, the time needed for the drying of the coated part 1 may be long. When the wind speed of the hot air H exceeds 15 m/s, the surface of the coated part may be wavy, which may cause a decrease in quality.

### Manufacturing Method for Electrode Sheet

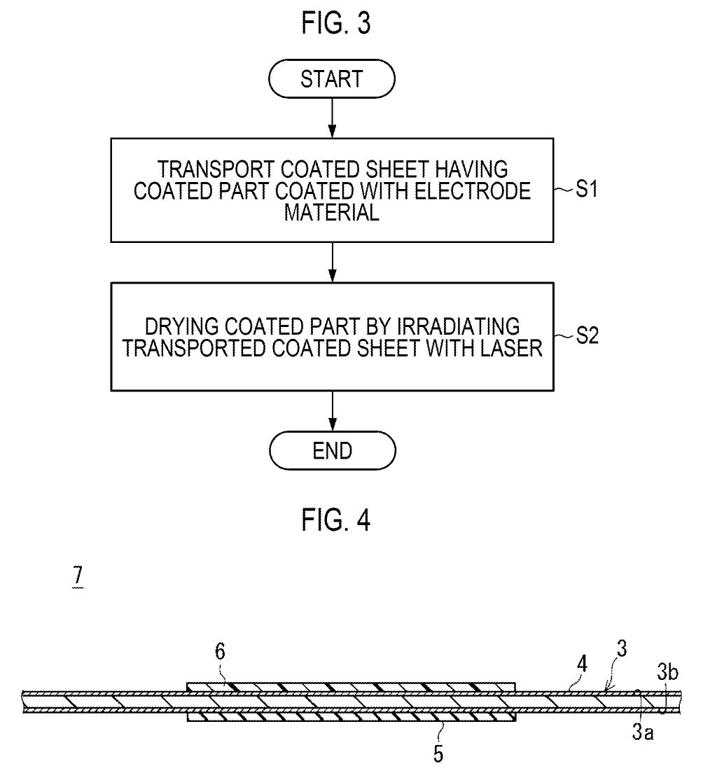

FIG. 3 is a flowchart showing a manufacturing method for an electrode sheet according to Embodiment 1. As shown in FIG. 3, the manufacturing method for the electrode sheet according to Embodiment 1 includes a transport step of S1 and a drying step of S2.

### Transport Step

The transport step is executed by the transport device 10. The transport step is a step of transporting the coated sheet 2 in a state where the second surface 2b of the coated sheet 2 on the side opposite to the first surface 2a on the coated part 1 side of the coated sheet 2 having the coated part 1 coated with the electrode material on the first surface 3a of the current collector sheet 3 is supported.

### Drying Step

The drying step is executed by the laser irradiation device 20. The drying step is a step of drying the coated part 1 by irradiating the coated sheet 2 to be transported with the laser L from the laser irradiation device 20. The laser irradiation device 20 is disposed on the second surface 2b side of the coated sheet 2 to be transported, and irradiates the laser L toward the second surface 2b of the coated sheet 2. By the drying step, the coated part 1 can be dried to obtain the electrode sheet.

The drying step may include supplying the coated part 1 of the transported coated sheet 2 with the hot air H. As a result, the coated part 1 can be efficiently dried. The hot air H is supplied from the hot air supply device described above.

### Electrode Sheet

FIG. 4 is a cross-sectional view showing the electrode sheet. As shown in FIG. 4, the electrode sheet 7 manufactured in the present disclosure has a current collector sheet 3 and an electrode layer 6 formed on the first surface 3a of the current collector sheet 3. The electrode sheet 7 may have the electrode layer 5 on the second surface 3b of the current collector sheet 3. That is, the electrode sheet 7 may have the electrode layers 5, 6 on both surfaces of the first surface 3a and the second surface 3b of the current collector sheet 3. The electrode layer 6 formed on the first surface 3a of the current collector sheet 3 may be a positive electrode active material layer or a negative electrode active material layer. In a case of the electrode sheet 7 having the electrode layers 5, 6, both the electrode layer 6 formed on the first surface 3a of the current collector sheet 3 and the electrode layer 5 formed on the second surface 3b of the current collector sheet 3 may be a positive electrode active material layer. Both electrode layers 5 may be a negative electrode active material layer. One electrode layer 5 may be a positive electrode active material layer, and the other electrode layer 5 may be a negative electrode active material layer. Although not shown, the electrode sheet 7 may not have the electrode layer 5 on the second surface 3b of the current collector sheet 3.

The type of the battery using the electrode sheet 7 is not particularly limited, and examples thereof include a lithium ion secondary battery. Examples of the use of the battery include a power source of a vehicle, such as a hybrid electric vehicle (HEV), a plug-in hybrid electric vehicle (PHEV), a battery electric vehicle (BEV), a gasoline vehicle, and a diesel vehicle. In particular, the battery is preferably used as a drive power source of a hybrid electric vehicle (HEV), a plug-in hybrid electric vehicle (PHEV), or a battery electric vehicle (BEV). The battery may be used as a power source of a moving body other than a vehicle (for example, a train, a ship, or an airplane), or may be used as a power source of an electrical product, such as an information processing device.

Hereinafter, examples and comparative examples will be shown to further describe the present disclosure.

### Example 1

As shown in FIG. 1, a coated sheet 2 having a coated part 1 in which a positive electrode material was coated on the first surface 3a of a current collector sheet 3 having a carbon coating layer 4 on both surfaces of the first surface 3a and the second surface 3b was prepared via the carbon coating layer 4. The current collector sheet 3 used a foil integrated by bonding an aluminum foil and a copper foil. The positive electrode material contains lithium iron phosphate as a positive electrode active material, styrene-butadiene rubber as a binder, carbon nanotube as a conductive material, and carboxymethylcellulose as a thickener.

On the second surface 2b of the prepared coated sheet 2, the negative electrode active material layer that is the electrode layer 5 was provided through the carbon coating layer 4. The negative electrode active material layer is formed in advance before the formation of the coated part 1. That is, the prepared coated sheet 2 had the carbon coating layer 4 and the negative electrode active material layer as a black portion. The negative electrode active material layer contains artificial graphite as a negative electrode active material, styrene-butadiene rubber as a binder, carbon nanotubes as a conductive material, and carboxymethylcellulose as a thickener.

Then, the manufacturing apparatus 100 was used to dry the coated part 1 by irradiating the second surface 2b of the coated sheet 2 with the laser L by the laser irradiation device 20 while transporting the coated sheet 2 by the transport device 10 in a state in which the second surface 2b of the coated sheet 2 is supported.

In the transport step, the coated sheet 2 was transported by the transport device 10 at a transport speed of 30 m/min. In the drying step, while irradiating the coated sheet 2 with a continuous-wave laser L at an energy density of 0.5 W/cm² using the laser irradiation device 20, hot air H at a temperature of 120°C and a wind speed of 5 m/s was supplied to the coated part 1 by a hot air dryer. The laser L was irradiated to the coated sheet 2 until the surface temperature of the coated part 1 exceeded 120°C. In order to prevent the temperature from rising excessively, the irradiation of the coated sheet 2 with the laser L was stopped immediately after the surface temperature of the coated part 1 exceeded 120°C.

In such a manner, the electrode sheet of Example 1 was manufactured.

### Example 2

As shown in FIG. 2, the electrode sheet of Example 2 was manufactured in the same manufacturing method as in Example 1 by using the same manufacturing apparatus 100 as in Example 1, except that the negative electrode active material layer was not provided on the second surface 2b of the coated sheet 2. That is, the prepared coated sheet 2 had the carbon coating layer 4 as a black portion.

### Comparative Example

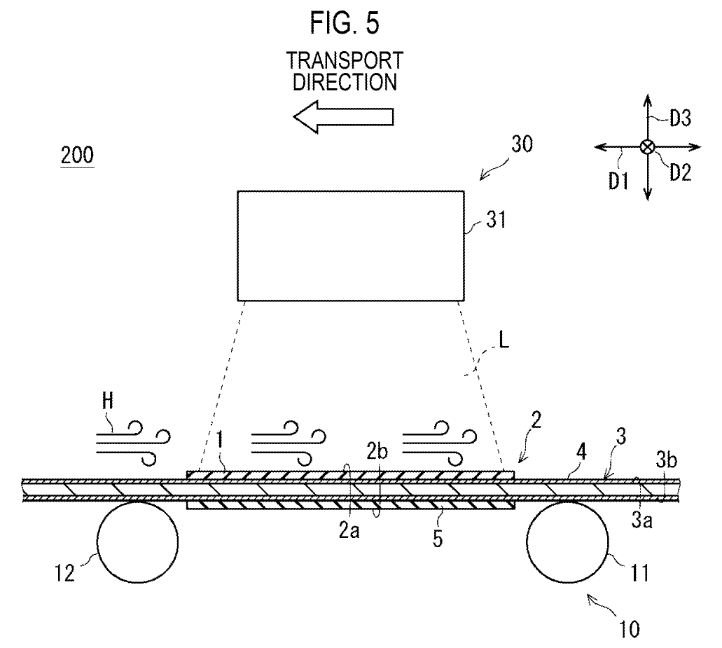

Here, FIG. 5 is a diagram showing a configuration of a manufacturing apparatus for an electrode sheet according to a comparative example. As shown in FIG. 5, a manufacturing apparatus 200 that is a manufacturing apparatus for an electrode sheet according to a comparative example has the same configuration as the manufacturing apparatus 100 except that a laser irradiation device 30 is provided instead of the laser irradiation device 20.

The laser irradiation device 30 of the manufacturing apparatus 200 dries the coated part 1 by irradiating the coated sheet 2 transported by the transport device 10 with a laser. The laser irradiation device 30 is disposed on a first surface 2a side of the coated sheet 2 to be transported by the transport device 10, and has a laser head 31 that irradiates the laser L toward the first surface 2a of the coated sheet 2.

An irradiation direction of the laser L shown in FIG. 5 is a direction from one side (upper side) of the third direction D3 to the other side (lower side). Therefore, the laser irradiation device 30 irradiates the coated sheet 2 with the laser L from the laser head 31, the coated sheet 2 passing below the laser head 31.

In the comparative example, the manufacturing apparatus 200 shown in FIG. 5 was used to transport the coated sheet 2 by the transport device 10 while the laser L was irradiated toward the first surface 2a of the coated sheet 2 by the laser irradiation device 30 in a state where the second surface 2b of the coated sheet 2 was supported. The coated part 1 was dried by the irradiation of the laser L. The manufacturing conditions including the transport speed of the coated sheet 2, the energy density of the laser L, the oscillation, the temperature and the wind speed of the hot air H, and the condition for stopping the irradiation of the laser L were the same as those in Example 1.

In such a manner, the electrode sheet of Comparative Example was manufactured.

### Evaluation

The coated part 1 during drying is heated by the irradiation of the laser L, and thus the surface temperature increases with the passage of time. Therefore, in each of the manufacturing processes of the electrode sheets of Examples 1 and 2 and Comparative Examples, the change in the surface temperature of the coated part 1 with time during drying was measured, and the product quality of laser drying was evaluated. The surface temperature of the coated part 1 was measured using a radiation thermometer.

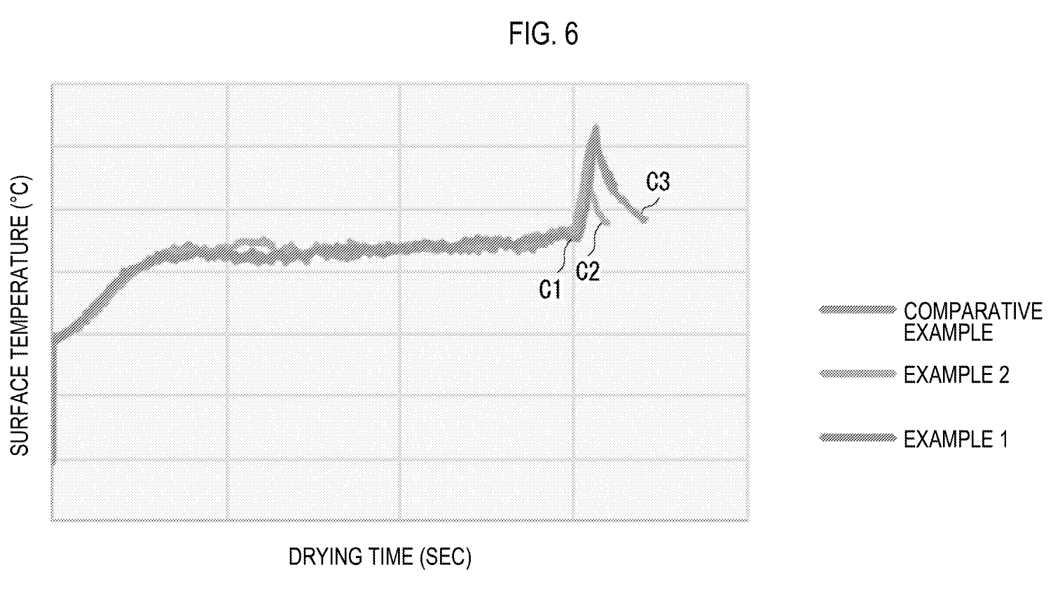

FIG. 6 is a graph showing a change with time of the surface temperature of the coated part during drying. A vertical axis of a graph shown in FIG. 6 is a surface temperature (°C) of the coated part 1, and a horizontal axis of the graph shown in FIG. 6 is a drying time (seconds). The drying time is a time for which the laser L is irradiated. The product quality of the laser drying was evaluated based on curves C1, C2, C3 showing the change over time of the surface temperature of the coated part 1.

A curve C1 shown in FIG. 6 shows a change with time of the surface temperature of the coated part 1 during drying, which is measured in a process of manufacturing the electrode sheet of Example 1. A curve C2 shown in FIG. 6 shows a change with time of the surface temperature of the coated part 1 during drying, which is measured in a process of manufacturing the electrode sheet of Example 2. A curve C3 shown in FIG. 6 shows a change with time of the surface temperature of the coated part 1 in the drying process of manufacturing the electrode sheet according to the comparative example.

As can be seen from the graph shown in FIG. 6, the result was obtained that the behavior of the temperature is almost the same in Examples 1 and 2 and Comparative Example when the curves C1, C2, C3 are compared. As a result, it was confirmed that the product quality of laser drying was the same regardless of the irradiation direction of the laser L.

However, in the case of the manufacturing apparatus 200, as shown in FIG. 5, a disposition space of the transport device 10 is needed on the second surface 2b side of the coated sheet 2, and a disposition space of the laser irradiation device 30 is needed on the first surface 2a side of the coated sheet 2. Therefore, in the manufacturing apparatus 200, there is a problem that the cost, such as the amount of equipment investment or the running cost, may increase as the device is increased in size.

On the other hand, in the case of the manufacturing apparatus 100, as shown in FIGS. 1 and 2, the laser L is irradiated on the coated sheet 2 from the second surface 2b side of the coated sheet 2 on the side where the transport device 10 is disposed. Therefore, each of the disposition spaces of the transport device 10 and the laser irradiation device 20 is gathered on the second surface 2b side of the coated sheet 2. The manufacturing apparatus 100 effectively uses a space on the second surface 2b side of the coated sheet 2, which is a dead space in the case of the manufacturing apparatus 200, as a disposition space of the laser irradiation device 20. Therefore, the manufacturing apparatus 100 can be reduced in height by at least the height of the transport rollers 11, 12 as compared with the manufacturing apparatus 200.

Therefore, according to the present embodiment, it is possible to provide an electrode sheet manufacturing apparatus and an electrode sheet manufacturing method capable of suppressing an increase in cost due to an increase in size of the device by realizing a reduction in size of the device.

The present disclosure is not limited to the embodiment, and can be appropriately modified without departing from the spirit. For example, the transport rollers 11, 12 can be changed to a belt conveyor having a plurality of rollers disposed away from each other in the first direction D1 and a belt straddling the rollers. The belt conveyor is disposed on the second surface 2b side of the coated sheet 2 and is a support member that supports the second surface 2b of the coated sheet 2.

What is claimed is:

1. A manufacturing apparatus for an electrode sheet, the manufacturing apparatus comprising:
a transport device configured to transport a coated sheet including a coated part in a state where a second surface on an opposite side of the coated sheet from a first surface of the coated sheet on a coated part side is supported, the coated part being coated with an electrode material on a first surface of a current collector sheet; and
a laser irradiation device configured to dry the coated part by irradiating the coated sheet transported by the transport device with a laser, wherein the laser irradiation device includes a laser head disposed on a second surface side of the coated sheet transported by the transport device, the laser head being configured to irradiate the coated sheet with the laser in a direction toward the second surface of the coated sheet.

2. The manufacturing apparatus according to claim 1, wherein:
the coated sheet has a black portion on a second surface on an opposite side of the current collector sheet from the first surface of the current collector sheet; and
the black portion is provided at a position where at least a part of the black portion overlaps the coated part when viewed in a thickness direction of the coated sheet.

3. The manufacturing apparatus according to claim 2, wherein the black portion is at least one of a carbon coating layer and an electrode layer.

4. The manufacturing apparatus according to claim 1, wherein the laser includes a semiconductor laser.

5. A manufacturing method for an electrode sheet, the manufacturing method comprising:
transporting a coated sheet including a coated part in a state where a second surface on an opposite side of the coated sheet from a first surface of the coated sheet on a coated part side is supported, the coated part being coated with an electrode material on a first surface of a current collector sheet; and
drying the coated part by irradiating the coated sheet transported with a laser from a laser irradiation device, wherein the laser irradiation device is disposed on a second surface side of the coated sheet transported and irradiates the coated sheet with the laser in a direction toward the second surface of the coated sheet.
